(19) United States
(12) Patent Application Publication
(10) Pub. No.: US 2024/0226746 A1
(43) Pub. Date: Jul. 11, 2024

(54) DEVICE AND METHOD FOR SIMULATING A VIDEO GAME ENVIRONMENT ON AN ELECTRONIC GAMING DEVICE

(71) Applicant: Garena Online Private Limited, Singapore (SG)

(72) Inventor: Harold TEO Ron Han, Singapore (SG)

(21) Appl. No.: 18/405,163

(22) Filed: Jan. 5, 2024

(30) Foreign Application Priority Data
Jan. 5, 2023 (SG) 10202300030U

(51) Int. Cl. A63F 13/58; A63F 13/69

(52) U.S. Cl. CPC A63F 13/58; A63F 13/69

(57) ABSTRACT

Systems, methods, and non-transitory computer-readable mediums are provided for simulating a video game environment. For example a method may include determining a score for each component of a multi-component relationship between a player character and a game object based on game data and user input to an electronic gaming device specifying actions of the player character. In some examples, each component may be associated by the game data with one or more game elements. Additionally, the method may include determining, in a game event related to the game object and for at least one component of the multi-component relationship, a result of the game event based on the one or more game elements associated with the at least one component and the score of the at least one component. Further, the method may include simulating a video game environment on an electronic gaming device according to the determined result.

### CROSS REFERENCE TO RELATED APPLICATIONS

This patent application claims the benefit and priority of Singaporean Patent Application No. 10202300030U, filed with the Intellectual property Office of Singapore on Jan. 5, 2023, entitled “DEVICE AND METHOD FOR SIMULATING A VIDEO GAME ENVIRONMENT ON AN ELECTRONIC GAMING DEVICE,” the contents of which are incorporated by reference in their entirety.

### TECHNICAL FIELD

Various aspects of this disclosure relate to devices and methods for simulating a video game environment on an electronic gaming device.

### BACKGROUND

In many computer games, there are non-hostile non-player characters with which a player may interact to unlock certain features. This may include bonuses for the non-player characters as well as content (e.g. a non-player character (which may include a whole faction)) may provide access to content such as a region of the game world.

A typical aim when designing a computer game is that the player gets the impression that his or her actions have an impact on the game environment (including the game world). A relationship system may aid in this, since the game environment is controlled in such a manner that player behaviour as impacts on what happens in the game environment, i.e. how gaming events play out. However, in a relationship system where a player character is simply liked more or less by a non-player character depending on player actions (e.g. give a gift, liked more, steal, liked less), this kind of mechanic may feel predictable and boring for the player and give little motivation for the player to work on his or her relation with the non-player character.

Accordingly, more complex approaches for simulating a video game environment regarding relations to non-player characters (or generally game objects) are desirable.

### SUMMARY

Various embodiments concern a method for simulating a video game environment on an electronic gaming device, comprising determining, depending on user input to the electronic gaming device specifying actions of a player character controlled by a user, a score for each component of a multi-component relationship between the player character and a game object (e.g. a non-player character), wherein each component of the multi-component relationship is associated by the game data with one or more game elements and determining, in a game event related to the game object, for at least one component of the multi-component relationship, a result of the game event from the game element associated with the at least one component depending on the score of the at least one component and simulating the video game environment on the electronic gaming device according to the determined result.

According to one embodiment, the game element is a combat bonus type.

According to one embodiment, wherein the game event is a combat between the player character and one or more enemies, in which the game object helps the player character.

According to one embodiment, the method comprises determining, in the combat between the player character and one or more enemies, for each component, a combat bonus value of the combat bonus type associated with the component depending on the score of the component and resolving the combat according to the determined combat bonuses.

According to one embodiment, the combat bonus value is a combat bonus value for the game object.

According to one embodiment, the combat bonus types include life, attack power and defence.

According to one embodiment, the game element is access control to respective game content.

According to one embodiment, the components are associated with different game content, wherein for each component, access to the game content associated with the component is controlled depending on the score of the component.

According to one embodiment, the components are associated with different regions of a game world of the game environment.

According to one embodiment, the method comprises determining a title for the multi-component relationship between the player character and the game object from a combination of the scores of the components of the multi-component relationship.

According to one embodiment, the method comprises determining, for each component, a proportion of the score of the component to the sum of the scores of the components and determining the title from the determined proportions.

According to one embodiment, the method comprises determining the title based on a comparison of each determined proportion with a respective threshold.

According to one embodiment, the method comprises displaying the determined title to the user as characteristic of the player character.

According to one embodiment, the components comprise an intimacy level, a passion level and a responsibility level.

According to one embodiment, the player character is controlled by the user by input to a gaming device presenting the game environment to the user.

According to one embodiment, a gaming system is provided comprising a user interface, a memory interface and a processing unit configured to perform the method of any one of the embodiments described above.

According to one embodiment, a computer program element is provided comprising program instructions, which, when executed by one or more processors, cause the one or more processors to perform the method of any one of the embodiments described above.

According to one embodiment, a computer-readable medium is provided comprising program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 shows a screen showing a graphical user interface of a computer game.

FIG. 2 shows a visual representation of a relationship of a player character with a non-player character.

FIG. 3 shows a flow diagram illustrating a method for simulating a video game environment on an electronic gaming device according to an embodiment.

FIG. 4 shows a gaming system according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

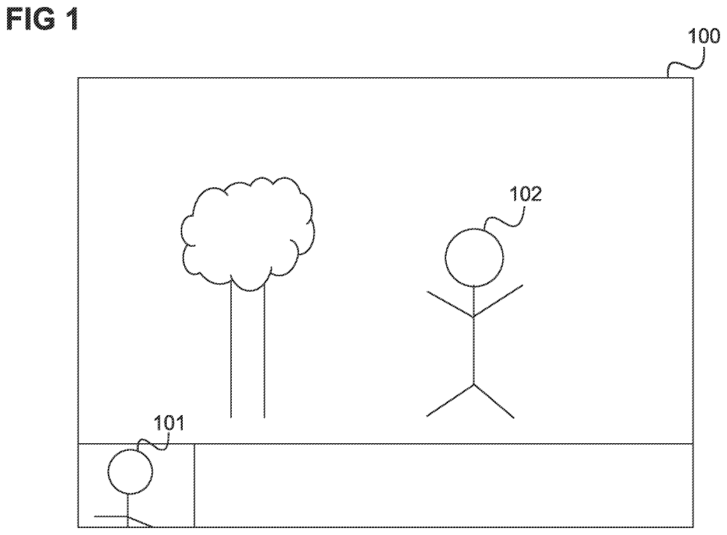

FIG. 1 shows a screen 100 showing a graphical user interface of a computer game 100.

The screen is for example a TV screen, computer monitor screen, or a smartphone or tablet screen used by a user to play a computer game.

The graphical user interface mainly shows a virtual game world, including a landscape and the visual representation, in this example, a of a non-player character 102. Depending on whether the game is in a 3rd person or first person view, a player character may also be represented as part of the game world. In this example, however, it is assumed that the player character is simply visually represented by a portrait 101. In the following, the non-player character and player character are used interchangeably with their visual representations 101, 102 for simplicity. It should be noted that the player character 101 and the non-player character 102 are further represented by one or more data structures holding data about the respective character.

In particular, such a data structure holds information about the connection that the player character 101 has with the non-player character 102 (e.g. about the affinity the non-player character 102 has for the player character 101). This means that the game contains a relationship (or “bond”, “connection” or “affinity” system): the non-player character 102 likes the player character more or less (e.g. the player character has a certain connection with the non-player character 102) and depending on how much the non-player 102 likes the player character game elements may be different (e.g. certain values may be different).

Such a relationship system in the game may have a linear (and thus relatively simple) design, which unlocks different features (e.g. content or bonuses) at different relationship levels. This, however, may lead to a relatively boring gaming experience and little replay value.

According to various embodiments, in contrast, there is a multi-component relationship between the player character and the non-player character, e.g. there is a value for each of multiple components, wherein each component expresses a different aspect of the relation between the player character and the non-player character.

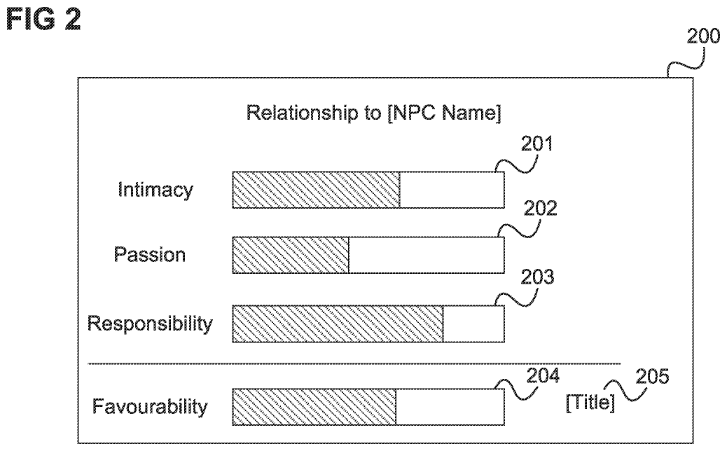

FIG. 2 shows a visual representation 200 of a relationship of a player character with a non-player character.

FIG. 2 shows an example set of components and a relationship value for the sake of illustrating certain aspects of the subject technology. In other embodiments, additional or alternative components and relationship values may also be used.

The visual representation 200 is for example displayed when the user opens a respective menu regarding the relationship to the non-player character 102. For example, the information that is displayed is per NPC (e.g., a data structure holding the information also includes a NPC identifier or a relationship identifier that maps between the player character and the NPC).

A user (e.g., a player) inputs commands when playing the game, and the game engine outputs results of this input, in particular resulting changes of the scores of the various components of the relationship system. For example, the scores are influenced by a gift system (which is, along with the relationship system, a component of the game engine): each gift has at least one inherent relationship type (e.g. an associated component of the relationship system) such that giving different gifts to the non-player character increases scores of the different components.

In this example, each component of the multi-dimensional relationship is represented by a respective bar 201, 202, 203 that the player fills with actions from, for example, zero, to a maximum score. The relationship may also include ranks for each component, e.g. the bar 201, 202, 203 for a component is for example filled and when completely filled, the corresponding relationship component ranks up by one rank.

It should be noted that player actions may also reduce the score of a relationship component, e.g. unfriendly behaviour may reduce the score of a certain relationship component.

In the present example, there are three components (e.g. the multi-dimensional relationship system comprises elements of three dimensions):
Intimacy level: players upgrade the intimacy level by obtaining intimacy (e.g. in form of intimacy points) with the non-player character in the game. There is an upper limit of level, which is equal to the maximum value of favourability level.
Passion level: players can upgrade the passion level by obtaining passion (e.g. in form of points) with the non-player character in the game. There is an upper limit for the level, which is equal to the maximum favourability level, and the initial level is 0.
Responsibility level: players can upgrade the responsibility level by obtaining responsibility value with regard to the non-player character in the game. There is a level upper limit, which is equal to the maximum favourability level, and the initial level is 0.

Here, the favourability level, displayed in a fourth bar 204 in the example of FIG. 2, refers to the value that quantifies the degree of preference between characters and between players and characters. Its value is a function of intimacy level, passion level, and responsibility level, and there is a favourability level upper limit. For example, the favourability level may be calculated based on the sum or average of the intimacy level, passion level, and responsibility level. Other functions, weightings, biases, or other factors may also be applied to the calculation of the favourability level. The maximum value of the favourability level may be different for different non-player characters (e.g. for non-player characters of different qualities).

The intimacy level, passion level and responsibility level result in a (favourability) title 205 for the player character (with regard to the relationship with the non-player character). The title 205 is one or more words which describe the relationship between the player character and the respective non-player character. For example, the relationship system predefines a set of titles such as “like”, “infatuated”, “empty”, “romantic”, “partner”, “stupid style”, “perfect style” and “no love”.

So, different scores of the various components of the relationship system give different favourability grades (or ranks). In the example of FIG. 2, the title is determined according to the numerical relationship between the passion level, the responsibility level, and the intimacy level. According to the proportion of the three-element levels, the title of favourability is determined based on a comparison of proportions with respective thresholds, e.g. according to table 1, wherein

Proportion of intimacy level(X)=Intimacy level/Favourability level

Proportion of passion level(Y)=Passion level/Favourability level

Responsibility Level Proportion(Z)=Responsibility Level/Favourability Level

TABLE 1

| NO. | Title | Conditions (And) |
|---|---|---|
| 1 | No-love | X + Y + Z = 0 |
| 2 | Fond bond | ½ < X ≤ 1 |
| | | 0 ≤ Y < ⅓ |
| | | 0 ≤ Z < ⅓ |
| 3 | Obsessive bond | 0 ≤ X < ⅓ |
| | | ½ < Y ≤ 1 |
| | | 0 ≤ Z < ⅓ |
| 4 | Hollow bond | 0 ≤ X < ⅓ |
| | | 0 ≤ Y < ⅓ |
| | | ½ < Z ≤ 1 |
| 5 | Romantic bond | ⅓ ≤ X ≤ ⅔ |
| | | ⅓ ≤ Y ≤ ⅔ |
| | | 0 < Z < ¼ |
| 6 | Companion bond | ⅓ ≤ X ≤ ⅔ |
| | | 0 ≤ Y ≤ ¼ |
| | | ⅓ ≤ Z ≤ ⅔ |
| 7 | Stupid bond | 0 ≤ X ≤ ¼ |
| | | ⅓ ≤ Y ≤ ⅔ |
| | | ⅓ ≤ Z ≤ ⅔ |
| 8 | Perfect bond | ¼ < X < ½ |
| | | ¼ < Y < ½ |
| | | ¼ < Z < ½ |

Table 1 shows the value range of each title. The title may be purely cosmetic but the associated favourability grade may affect gameplay, like allow access to certain content such as game world areas, equipment or skills. Several characteristics can be seen from table 1 in this example:
The conditions required to achieve the perfect bond are harsh
The values on the boundary cannot be smoothly transited. There are parameters to control the conversion from one title to another, and a certain degree of numerical accumulation is required
Initial title: no love

Each component is associated by the game data with one or more game elements, wherein different components may be associated with different game elements. For example, game elements may include game play modifiers such as combat (e.g. battle) bonuses but different component relate to different types of combat bonuses such that each component brings a different battle bonus. For example, a high intimacy level will increase the life value of the non-player character (when helping the player character in combat as companion), high passion level increases the non-player character's attack power and responsibility level increases the non-player character's defence capability. Another example may be respawn speed in a game where non-player characters may respawn (e.g. become available after some time depending on the score of a respective component after having been incapacitated).

Game elements may also be content. For example one component of the relationship system may be associated with content, such as a game world region (e.g. the non-player character's house) and the game engine decides depending on the score of the content whether the player character may access the content (e.g. enter the region such as the house).

In other words, it is decided in a game event related to the non-player character (e.g. combat in which the non-player character helps or a region whose access depends on the non-player character, e.g. which is guarded by the non-player component), for at least one of the components, a result of the game event (e.g. outcome of combat or a combat action or whether the player character may enter a region) from the game element (e.g. combat bonus, content (e.g. region) access control) associated with the component depending on the score of the component.

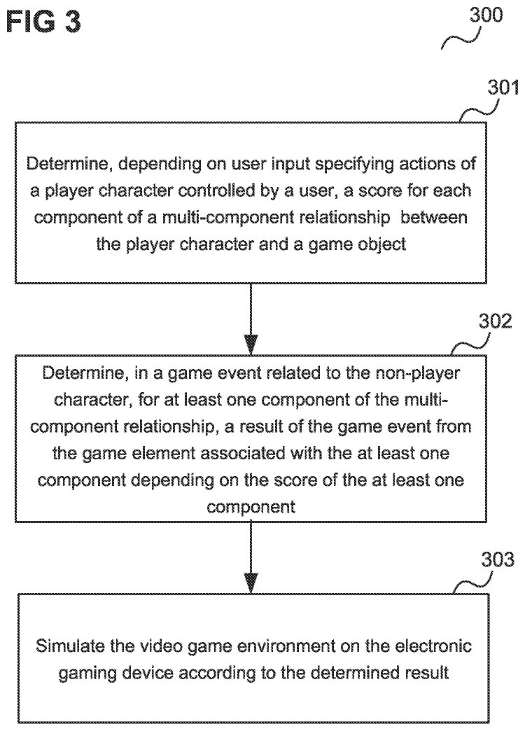

According to one embodiment, a method is provided as illustrated in FIG. 3.

FIG. 3 shows a flow diagram illustrating a method for simulating a video game environment on an electronic gaming device according to an embodiment.

In 301, depending on user input to the electronic gaming device specifying actions of a player character controlled by a user, a score for each component of a multi-component relationship between the player character and a game object (e.g. a non-player character, a faction, an environment etc.) defined in game data is determined, wherein each component of the multi-component relationship is associated by the game data with one or more (respective) game elements (e.g. such that the different components are associated with different game elements).

In 302, in a game event related to the game object, for at least one component of the multi-component relationship, a result of the game event is determined from the game element associated with the at least one component depending on the score of the at least one component.

In 303, the video game environment is simulated on the electronic gaming device according to the determined result. Thus, the user of the gaming device experiences the game event, e.g. by display of certain content, sound, and/or controller vibration.

According to various embodiments, in other words, a multi-dimensional relationship (or “bond”) system is provided in a game. Player behaviour affects different components (e.g. aspects) of the relationship between the player and a game object. In other words, players can affect their relationship with the player character in different directions (e.g. dimensions). Thus, the effect of player behaviour on the relationship, e.g. how the player cultivates the relationship with the game object, is made more complex (e.g. entropy is increased) which enriches the game experience of players in games with relationship systems (in comparison with the “one-dimensional”experience of a linear relationship systems by enriching the experience to a multi-dimensional form). Furthermore, this provides a carrier for content in the design of content-based games and for example allows more complex combinations of content that a player experiences (depending on the player's behaviour) which, for example, may increase replayability (e.g. replay value). For example, more complex non-player characters and plots may be included in the game and the player may experience different combinations of plot elements and non-player character actions (or generally non-player character behaviour) depending on the player's behaviour. The relationship system can thus be used for games with different orders of content which may be flexibly configured for the multiple dimensions of the relationship system. Content may be provided via an update mechanism.

According to various embodiments, in other words, an entropy increasing bonding system or a multi-branch bonding outcome system based on player behaviour is provided. Through different interactions between player character and non-player characters in the game and according to a numerical range determined by the entropy increasing bonding ternary system, a bonding outcome (regarding to the player character and/or non-player characters) is obtained.

It should be noted that the relationship of the player character with a non-player character may be that of the player character with a whole faction (to which the non-player character belongs).

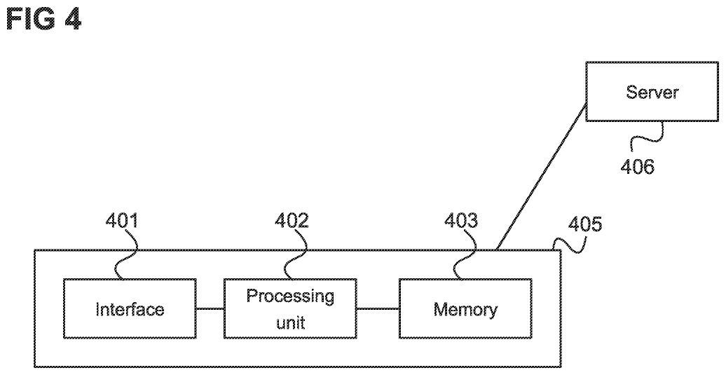

The method of FIG. 3 is for example carried out by a gaming system as illustrated in FIG. 4.

FIG. 4 shows a gaming system 400 according to an embodiment.

The gaming system 400 includes an electronic (user) gaming device 405 (such as a computer, mobile telephone, console, etc.) which has a user interface 401 (e.g. configured to receive user input). The gaming device 400 further includes a processing unit 402 and a memory 403. The memory 403 may be used by the processing unit 402 to store, for example, data to be processed, such as program code of the game (including the game engine) and information about game content as well as the scores for the components of the relationship system. The processing unit 402 processes the data, e.g. to execute the game engine and to present the game environment (visually, on a screen of the gaming device 405, e.g. corresponding to screen 100) to the user (e.g. player).

The gaming system 400 is configured to perform the method of FIG. 3. It should be noted that the game environment may be understood to comprise the game world (e.g. data describing the game world) but also various elements relating to game mechanics such as e.g. data structure representing the status of the player character and the status non-player characters (including enemies) as well as control data regarding the state of the game with regard to, e.g. plot and access to regions of the game world, etc.

According to one embodiment, the determination of the scores and the result of the game event may for example be performed by the gaming device 405. According to one embodiment, the gaming system 400 further includes one or more gaming servers 406 (which for example transmit game control data to the electronic gaming device 405). The gaming device 405 may receive user input which (or information derived from the user input) it transmits to the one or more gaming servers 406. The one or more gaming servers 406 for example determine the scores and/or the result of the game event and notify the gaming device 405 accordingly. Similarly to the gaming device 405, the one or more gaming servers 406 may each comprise one or more interfaces, processing units and memories.

Depending on how the processing is distributed between the gaming device 405 and the one or more gaming servers 406, the game data is stored on the gaming device 405 and/or the gaming server 406.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed:

1. A method for simulating a video game environment on an electronic gaming device, comprising:
determining a score for each component of a multi-component relationship between a player character and a game object based on game data and user input to an electronic gaming device specifying actions of the player character, wherein each component of the multi-component relationship is associated by the game data with one or more game elements;
determining, in a game event related to the game object and for at least one component of the multi-component relationship, a result of the game event based on the one or more game elements associated with the at least one component and the score of the at least one component; and
simulating a video game environment on the electronic gaming device according to the determined result.

2. The method of claim 1, wherein the one or more game elements are a combat bonus type.

3. The method of claim 2, wherein the game event is a combat between the player character and one or more enemies and the game object helps the player character.

4. The method of claim 3, further comprising:
determining, in the combat between the player character and one or more enemies and for each component, a combat bonus value of the combat bonus type associated with the at least one component based on the score of the at least one component; and
resolving the combat according to the determined combat bonus value.

5. The method of claim 4, wherein the combat bonus value is a combat bonus value for the game object.

6. The method of claim 2, wherein the combat bonus type includes life, attack power and defence.

7. The method of claim 1, wherein the one or more game elements of each component of the multi-component relationship are access control to a respective game content.

8. The method of claim 7, wherein components of the multi-component relationship are associated with a different game content, wherein for each component of the multi-component relationship, access to the respective game content associated with the component is controlled based on the score of the component.

9. The method of claim 1, wherein components of the multi-component relationship are associated with different regions of a game world of the video game environment.

10. The method of claim 1, further comprising:
determining a title for the multi-component relationship between the player character and the game object from a combination of the scores of components of the multi-component relationship.

11. The method of claim 10, further comprising:
determining, for each component of the multi-component relationship, a proportion of the score of the component to a sum of the scores of the components of the multi-component relationship; and
determining the title from the determined proportions.

12. The method of claim 11, further comprising:
determining the title based on a comparison of the determined proportion of each component of the multi-component relationship with a respective threshold.

13. The method of claim 10, further comprising:
displaying the determined title to a user as characteristic of the player character.

14. The method of claim 1, wherein each component of the multi-component relationship comprises an intimacy level, a passion level, and a responsibility level.

15. The method of claim 1, wherein the player character is controlled by a user based on the user input to the electronic gaming device presenting the video game environment to the user.

16. A non-transitory computer readable medium comprising instructions that when executed by at least one processor, causes the at least one processor to:
determine a score for each component of a multi-component relationship between a player character and a game object based on game data and user input to an electronic gaming device specifying actions of a player character, wherein each component of the multi-component relationship is associated by the game data with one or more game elements;
determine, in a game event related to the game object and for at least one component of the multi-component relationship, a result of the game event based on the one or more game elements associated with the at least one component and the score of the at least one component; and
simulate a video game environment on the electronic gaming device according to the determined result.

17. The non-transitory computer readable medium of claim 16, wherein the one or more game elements are a combat bonus type.

18. The non-transitory computer readable medium of claim 17, wherein the game event is a combat between the player character and one or more enemies and the game object helps the player character.

19. The non-transitory computer readable medium of claim 18, wherein the at least one processor is further configured to:
determine, in the combat between the player character and one or more enemies and for each component, a combat bonus value of the combat bonus type associated with the at least one component based on the score of the at least one component; and
resolving the combat according to the determined combat bonus value.

20. A system comprising:
a memory storing instructions; and
at least one processor coupled to the memory, the at least one processor being configured to execute the instructions to:
determine a score for each component of a multi-component relationship between a player character and a game object based on game data and user input to an electronic gaming device specifying actions of a player character, wherein each component of the multi-component relationship is associated by the game data with one or more game elements;
determine, in a game event related to the game object and for at least one component of the multi-component relationship, a result of the game event based on the one or more game elements associated with the at least one component and the score of the at least one component; and
simulate a video game environment on the electronic gaming device according to the determined result.
